(19) United States
(12) Patent Application Publication
(10) Pub. No.: US 2025/0068630 A1
(43) Pub. Date: Feb. 27, 2025

(54) PERFORMING ITEM SEARCH IN A WAY THAT DYNAMICALLY SELECTS FIELDS TO MATCH AND TECHNIQUES FOR MATCHING

(71) Applicant: Cesium, Inc., San Jose, CA (US)

(72) Inventors: Przemyslaw Lelakowski, Gdansk (PL); Adrian Wozniak, Lodz (PL); Marcin Jedras, Wroclaw (PL); Patryk Tyszka, Lomza (PL); Sebastian Sito, San Jose, CA (US); Wojciech Krupa, San Jose, CA (US)

(21) Appl. No.: 18/813,804

(22) Filed: Aug. 23, 2024

Related U.S. Application Data
(60) Provisional application No. 63/578,356, filed on Aug. 23, 2023.

(51) Int. Cl. G06F 16/2453

(52) U.S. Cl. CPC G06F 16/24542

(57) ABSTRACT

A facility is described for searching a corpus. The facility receives a query string, and identifies concepts represented in it. The facility accesses an ordered series of query strategy stages, and loops through them beginning with a first stage until a stage is selected. In each iteration of the loop, the facility accesses a set of attributes among the corpus's attributes that is specified by the stage, and performs a pre-search to determine an extent to which concepts among those identified are represented among the values of the attributes of the set. Based on the determined extent, the facility determines whether the query strategy stage is satisfied and, if so, selects it. The facility performs a search to generate a search result identifying items of the corpus having values of at least some of the attributes of the set that each represent at least one of the identified concepts.

### CROSS-REFERENCE TO RELATED APPLICATIONS

This application claims priority to U.S. Provisional Patent Application No. 63/578,356, filed on Aug. 23, 2023 which is hereby incorporated by reference as in its entirety. Where a document incorporated herein by reference conflicts with the present application, the present application controls.

### BACKGROUND

Item search involves identifying items—such as products—among a set of items that satisfy a query. The set of items—including information about each item—is sometimes called a “corpus.” The level at which an item is found to satisfy a query tends to depend on the degree to which information about the item matches the query.

It is typical for a search engine to receive a query from a user, and generate a query result containing a list of items satisfying the query, sorted by their apparent levels of relevance to the query. In some cases, the query result is presented to the user on a result page, and for each item contains information about the items such as its name, an image, an availability level, a price, a description, an ordering control, and/or a link to an item detail page in which is presented a larger amount of information about the item.

### BRIEF DESCRIPTION OF THE DRAWINGS

FIG. 1 is a block diagram showing some of the components typically incorporated in at least some of the computer systems and other devices on which the facility operates.

FIG. 2 is a flow diagram showing an ingestion process performed by the facility in some embodiments.

FIG. 3 is a flow diagram showing a process performed by the facility in some embodiments in order to generate one or more series of query planning stages, used by the facility in some embodiments to perform user queries.

FIG. 4 is a flow diagram showing a process performed by the facility in some embodiments to process a user query.

FIG. 5 is a flow diagram showing the searching process performed by the facility based upon the example definition of searching stages shown in Table 17.

FIG. 6 is a graph diagram showing a sample graph relating query tokens and matched concepts.

FIG. 7 is a graph diagram showing a sample concept matching graph in which the matched concepts fully correspond to the tokens of the user query.

FIG. 8 is a graph diagram showing a sample graph relating fields and concepts that satisfies this requirement.

### DETAILED DESCRIPTION

The inventors have recognized that conventional search techniques produce poor results for certain item set domains. In particular, they have noted the poor performance of conventional search techniques for products in the chemical industry. Specifically, they observed that searching in this domain using conventional techniques tends to produce many false positives, and often also many false negatives.

In response to recognizing these disadvantages, the inventors have conceived and reduced to practice a software and/or hardware facility for performing item search in a way that dynamically selects fields to match and techniques for matching (“the facility”). In some embodiments, the facility is deployed to perform queries for an ecommerce platform for selling products in the chemical industry, such as those provided by multiple sellers. Those skilled in the art will recognize that the facility can be straightforwardly adapted to perform queries in a variety of other item set domains.

In some embodiments, the facility employs a series of query planning stages. In each of the query planning stages, the facility generates a proposed query plan graph to execute in the search engine to generate a query result for a particular user query. In general, each stage specifies a different set of fields to match to concepts appearing in the user query, and/or different matching standards or matching techniques for those fields. For each user query, the facility progresses through each stage, in order. In each stage, the facility generates a query plan graph for the user query using the fields and matching standards specified by the stage, and determines a level of suitability of the query plan graph by predicting aspects of the volume and/or quality of the query result that will be produced by executing the query plan graph. If the level of suitability determined by the facility for the query plan graph generated based on the present stage exceeds a suitability threshold, the facility omits subsequent stages, and submits this query plan graph to the search engine for execution to produce the query result. In some embodiments, the facility determines the level of suitability of a particular stage's graph using one or more success requirements specified for each stage.

In some embodiments, the facility performs matching based at least in part on concepts. The concept refers to a general idea that represents a group or category of related terms or entities. It goes beyond exact keyword matching and aims to capture the underlying meaning or semantic understanding of the information. For instance “red pigment” is a group that represents a type of pigment. When we separate this phrase into red and pigment keywords, its meaning will be changed and we could find not only red pigments but also red paint and pigments with different colors.

Chemical market concepts terms examples:
1. high density polyethylene hdpe
2. fda approved
3. recycled polymer
4. food ingredient

In some embodiments, the facility customizes different sets of the query planning stages to different searching profiles, and, for each user query, selects a profile whose stages it will apply to the user query. In various embodiments, each searching profile corresponds to a different subdomain, product vertical, searcher role, or searching purpose. In various embodiments, the facility determines the searching profile for a user query based on one or more of: per-query explicit selection; per-user explicit selection; automatic inference based on present user query; automatic inference based on history of user queries; automatic inference based on query results and interactions therewith; and automatic inference based on browsing actions.

By operating in some or all of the ways described above, relative to conventional search techniques, the facility tailors its approach to searching to aspects of the user query, employing a strategy that it predicts will be successful, yielding more helpful results for each user, in some cases taking into account differences in their needs. This in turn increases user satisfaction and efficiency, as well as product sales through the platform.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by skipping past stages predicted to produce over-voluminous, low-quality results, the facility saves the processor cycles needed to generate such results and explore them over a large period of time, and also saves the memory space needed to store these large results.

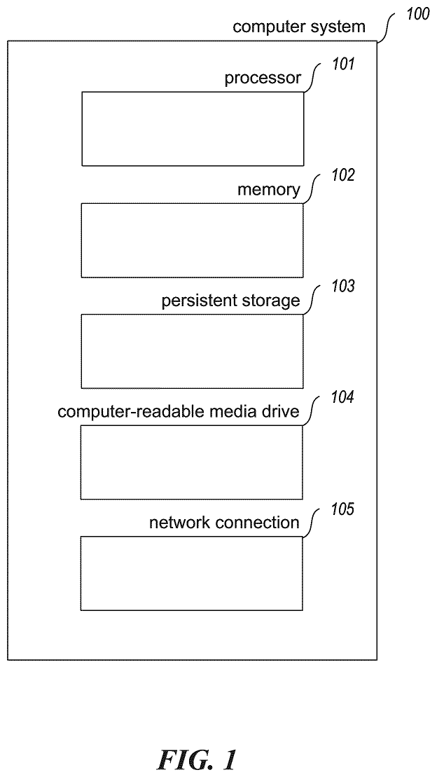

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

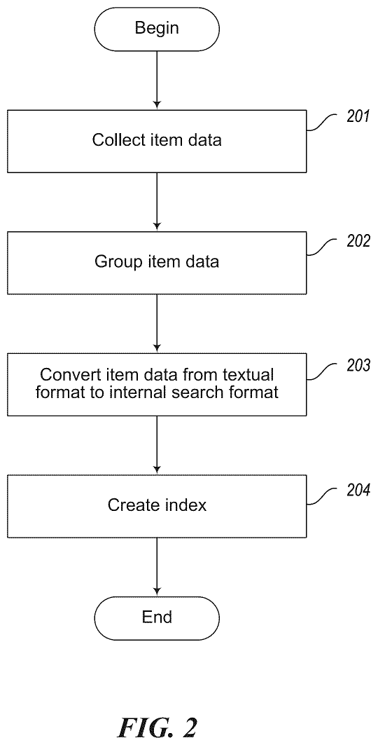

FIG. 2 is a flow diagram showing an ingestion process performed by the facility in some embodiments. In act 201, the facility collects item data (e.g., product data), transforming data from a product catalog into a format that is more suitable for the search. This data includes all information related to the product, such as its description attributes, manufacturer, etc. Then the data prepared in this way is saved to working state of a search engine used by the facility, such as ElasticSearch. This data will then be used as the primary data with which all search operations are performed using the semantic-search app. The product catalog data comes from the relational database, from which the data is extracted, its format modified to a format compatible with the semantic-search-data-ingest application, and stored in Redis key value store, that is used as intermediate repository. Semantic-search-ingestion-app reads catalog data from this intermediate repository instead of using relational database directly. By this approach, data changes at the relational database level do not affect the data format used by the semantic-search-ingestion-app. Table 1 below shows sample item data for a typical starch product. It uses text analyzers to convert the textual format into the internal ElasticSearch format used during the search. During this phase, text analyzers from relevancy-plugin are used.

```
TABLE 1
“id”: 427106,
“company_id”: 4348,
“brand_id”: 34023,
“name”: “NATIVE TAPIOCA STARCH ”,
“long_description”: “NATIVE TAPIOCA STARCH is a microbiological food (MF)
grade starch primarily intended for use in food products. It appears as a
white powder with a negligible odor. The product is manufactured in
compliance with all provisions of the Toxic Substances Control Act (TSCA).”,
“grade_name”: “NATIVE TAPIOCA STARCH ”,
“name_all_locales”: {
  “en_US”: “NATIVE TAPIOCA STARCH ”,
  “fr_FR”: “AMIDON DE TAPIOCA NATIF”
},
“long_description_all_locales”: {
  “en_US”: “NATIVE TAPIOCA STARCH is a microbiological food (MF) grade
starch primarily intended for use in food products. It appears as a white
powder with a negligible odor. The product is manufactured in compliance
with all provisions of the Toxic Substances Control Act (TSCA).”,
  “fr_FR”: “L'amidon de TAPIOCA NATIF est un amidon de qualité alimentaire
microbiologique (MF) principalement destiné à être utilisé dans les produits
alimentaires. Il se présente sous la forme d'une poudre blanche à l'odeur
négligeable. Le produit est fabriqué en conformité avec toutes les
dispositions du Toxic Substances Control Act (TSCA).”
}
```

The fragment above contains the following elements:
1. in line 1, id is an Entity Id from relational database
2. company_id and brand_id in lines 2 and 3 represent relations to other entities like company and brand in this example
3. name, long_description, seo_description, etc., in lines 4-12 represent entity attributes that could be used for searching purposes. Above data is used to show information about a particular entity. What is important, some of these attributes that are language dependent have an additional special version of itself with the suffix all_locales, which contains translations for individual languages. In the above example such attribute is long_description_all_locales. We It is included in lines 14-24 in two versions, one for English and the second for French language.

In act 202, the facility performs data reorganization by grouping the data into appropriate data structures. In act 203, the facility uses text analyzers to convert the textual format into the internal format used during the search, such as the ElasticSearch format. During this phase text analyzers from relevancy-plugin are used. Table 2 below shows a converted version of the data in Table 1.

```
TABLE 2
  “id” : 427106,
  “company_id” : 4348,
  “brand_id” : 34023,
  “name” : “NATIVE TAPIOCA STARCH ”,
  “long_description” : “NATIVE TAPIOCA STARCH is a microbiological
food (MF) grade starch primarily intended for use in food products. It
appears as a white powder with a negligible odor. The product is manufactured
in compliance with all provisions of the Toxic Substances Control Act
(TSCA).”,
  “fr~name” : “AMIDON DE TAPIOCA NATIF”,
  “fr~long_description” : “L'amidon de TAPIOCA NATIF est un amidon
de qualité alimentaire microbiologique (MF) principalement destiné à être
utilisé dans les produits alimentaires. Il se présente sous la forme d'une
poudre blanche à l'odeur négligeable. Le produit est fabriqué en conformité
avec toutes les dispositions du Toxic Substances Control Act (TSCA).”,
“tt_labeling_claims” : [
  “Naturally Derived”,
  “Halal”,
  “Kosher”,
  “Natural”,
  “Plant-Based”
],
“fr~tt_labeling_claims” : [
  “Naturel”,
  “À base de plantes”,
  “'origine naturelle”,
  “Cachère”,
  “Halal”
  ],
“range_ph” : {
  “gte” : 5.0,
  “lte” : 7.0
  },
```

The example shown in Table 2 includes simple attributes name and, long_description in lines 4-8, as well as language versions name fr˜name and fr˜long_description in lines 9-14. In lines 15-21, the facility has grouped taxonomy terms tt_labeling_claims. This is a way of marking fields that were generated from taxonomy_terms. Lines 29-31 show complex attributes in format to simplify range searching range_ph (gte greater or equal, lte lower or equal).

In act 204, the facility performs concept creation. Concepts are a result of analysis of other indexes (e.g., product_index, company_index, brand_index). Data from that analysis is categorized and stored as relevant concepts. Concepts store information about the phrase itself and its origin. The origin of the phrase is the information from which field it was extracted, as well as whether it is the original phrase or, for example, a synonym. We use that data later during the creation of the search query plan graph. In act 205, the facility uses the grouped item data and created concepts to capture an index after step 205, this process concludes.

Those skilled in the art will appreciate that the acts shown in FIG. 2 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

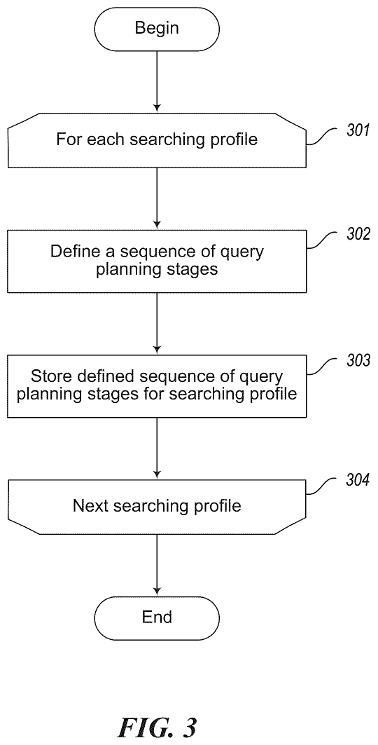

FIG. 3 is a flow diagram showing a process performed by the facility in some embodiments in order to generate one or more series of query planning stages, used by the facility in some embodiments to perform user queries. In acts 301-304, the facility loops through each of one or more searching profiles. In some embodiments, different searching profiles correspond to different search subdomains—i.e., different portions of the domain in which the facility is designed to search. In some embodiments, different searching profiles correspond to different product verticals within a broader product category in which the facility is designed to search. In some embodiments, different searching profiles correspond to different roles in which users of the facility search, sometimes relating to their position or assigned responsibilities within their company or other organization. In some embodiments, different searching profiles correspond to a different searching purpose presently being pursued by a user, which may vary from time to time for that user over intervals of varying length.

In act 302, the facility defines a sequence of query planning stages for the searching profile. In some embodiments, some or all of the query planning stages specify fields of the searched corpus to be matched in accordance with the query planning stage, such as by identifying these fields directly, and/or using regular expressions. In some embodiments, some or all of the query planning stages specify a matching standard or matching technique for use in matching concepts found in the inquiry to fields specified by the stage. These can be specified either across all of the stage's fields, or on a field-by-field basis, and can indicate, for example, a process to perform the matching, a minimum level of match that must be achieved, etc. In some embodiments, some or all of the stages specify requirements for success that determine whether the query plan graph generated by the stage is to be executed by the search engine to produce the query result for the query. These can include number of concepts matched within the specified fields, quality or strength of concept matches within the specified fields, etc. In some embodiments, some or all of the query planning stages specify weights for the fields identified by the stage. In various embodiments, these weights are used by the facility in evaluating the stage's success requirements against the stage's query plan graph, scoring and/or ranking the items in a query result generated by executing the stage's query plan graph, etc.

In some embodiments, each stage changes how we verify matched concepts, against the product_index.

Every stage defines what field and how should be matched, and what is its priority for each of them. Depending on the quality of the results returned from single verification, the search may execute the next stage or stop on the current one. A minimal one-stage needs to be executed for user search queries that contain valid concepts or keywords.

Stage search configuration contains information about
1. Field priority with a weight that will be used to calculate the relevancy score
2. Set of fields that should be used during the search
3. What kind of match should be used: perfect match, partial match, etc.
4. What are the minimum requirements for a stage to succeed

In act 303, the facility stores the sequence of query planning stages defined in act 302 in connection with the searching profile. In act 304, if additional searching profiles remain to be processed, then the facility continues in act 301 to process the next searching profile, else this process concludes.

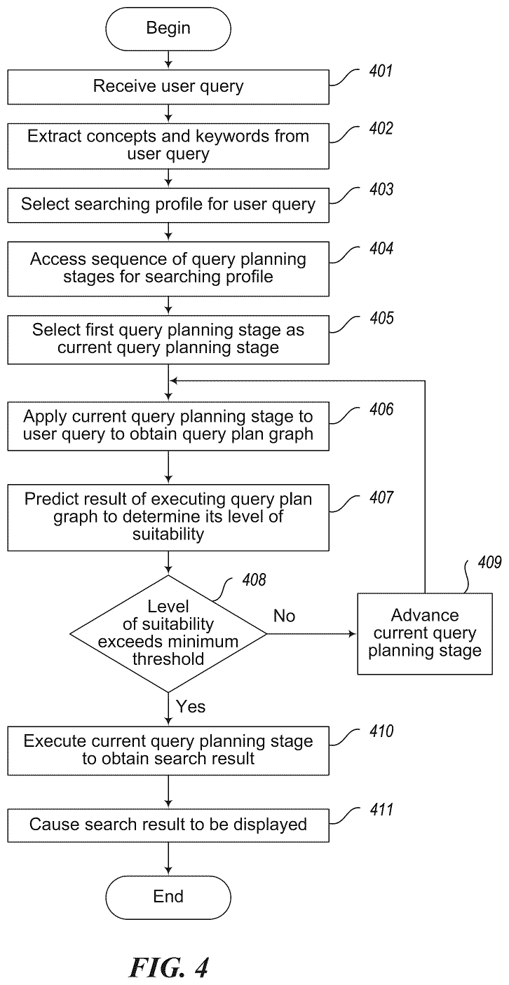

FIG. 4 is a flow diagram showing a process performed by the facility in some embodiments to process a user query. In act 401, the facility receives a user query from the user, such as a text string.

In act 402, the facility extracts concepts and keywords from the user group. Concepts or keywords are extracted based on predefined criteria on search terms analyzers level in semantic-search application. Text analysis is performed in the same way as it is done when creating concepts. This ensures that within the application the same input text will always be represented in the same way regardless of its origin.

In act 403, the facility selects a searching profile to apply in processing the user query received in act 401. In various embodiments, the facility selects the searching profile based upon factors such as an explicit searching profile selection made by the user in connection with the received query; an explicit selection made by the user with respect to all of the user's queries; automatically inferring a searching profile based upon the user query received in act 401; automatically inferring a searching profile based upon a longer history of the user's queries; automatically inferring a searching profile based upon results from the user's earlier queries and the user's interactions with those results; automatically inferring a searching profile based upon the user's browsing actions, such as their browsing actions with respect to a chemical industry product ecommerce platform; etc.

In act 404, the facility accesses the sequence of searching stages for the searching profiles selected in act 403. In act 405, the facility selects a first query planning stage of the accessed sequence as the current stage. In act 406, the facility applies the current stage to the user query to obtain a query plan graph. The query plan graph specifies a version of the query that could be submitted to the search engine for execution against the indices that the search engine uses to represent the contents of the corpus. The query plan graph represents combinations of concepts that will be searched for in particular fields of the index/corpus.

In act 407, the facility uses the search engine to perform a pre-execution step that predicts the result of executing the query plan graph obtained in act 406 to determine the level of suitability of the query plan graph. In some embodiments, the facility bases this level of suitability on the number of matches of concepts determined from the user's query within the fields specified by the stage, and/or the weights specified for those fields by the stage. In some embodiments, the level of suitability is determined by the facility relative to success requirements specified by the stage.

In act 408, if the level of suitability determined in act 407 exceeds a minimum suitability threshold, then the facility continues in act 410, else the facility continues 409. In act 409, the facility advances the current searching stage to the next stage of the searching stage series. After act 409, the facility continues in act 406 to apply the new current searching stage.

In act 410, the facility executes the current stage within the search engine to obtain a search result containing one or more items from the corpus. In act 411, the facility causes the search result obtained in act 410—in some cases after subjecting the search results to post-processing—to be displayed for viewing and interaction by the user. In some embodiments, these interactions can include placing orders for items that are products. After act 411, this process concludes.

In some embodiments, the items of the corpus that can be returned in a query result are referred to herein as entities. The information contained by the corpus for a particular sample product entity is shown below in Table 3.

```
TABLE 3
“id”: 427106,
“company_id”: 4348,
“brand_id”: 34023,
“name”: “NATIVE TAPIOCA STARCH ”,
“long_description”: “NATIVE TAPIOCA STARCH is a microbiological food
    (MF) grade starch primarily intended
    for use in food products. It appears as
    a white powder with a negligible odor.
    The product is manufactured in
    compliance with all provisions of the
    Toxic Substances Control Act (TSCA).”,
“grade_name”: “NATIVE TAPIOCA STARCH”,
“name_all_locales”: {
  “en_US”: “NATIVE TAPIOCA STARCH ”,
  “fr_FR”: “AMIDON DE TAPIOCA NATIF”
},
“long_description_all_locales”: {
  “en_US”: “NATIVE TAPIOCA STARCH is a microbiological food (MF)
    grade starch primarily intended for use
    in food products. It appears as a white
    powder with a negligible odor. The
    product is manufactured in compliance
    with all provisions of the Toxic
    Substances Control Act (TSCA).”,
  “fr_FR”: “L'amidon de TAPIOCA NATIF est un amidon de qualité
    alimentaire microbiologique (MF)
    principalement destiné à être utilisé
    dans les produits alimentaires. Il se
    présente sous la forme d'une poudre
    blanche à l'odeur négligeable. Le
    produit est fabriqué en conformité avec
    toutes les dispositions du Toxic
    Substances Control Act (TSCA).”
```

In Table 3, line 1 contains an identifier for this product entity. Lines 2 and 3 contain IDs identifying related company brand entities, respectively. Line 4 has a name for this product, and lines 6-11 a description. The entity contains additional information.

Table 4 below shows taxonomy terms used by the facility in some embodiments.

TABLE 4

```
“taxonomy_terms”: [
  {
    “id”: 26053,
    “facet_id”: 13,
    “facet_name”: “Labeling Claims”,
    “facet_name_all_locales”: {
      “en_US”: “Labeling Claims”,
      “fr_FR”: “Allégations sur l'étiquetage”
    },
    “facet_slug”: “labeling-claims”,
    “name”: “Natural”,
    “name_all_locales”: {
      “en_US”: “Natural”,
      “fr_FR”: “Naturel”
    },
    “slug”: “labeling-claims-natural”,
    “taxonomy_group_name”: “Benefits \u0026 Claims”,
    “taxonomy_group_name_all_locales”: {
      “en_US”: “Benefits \u0026 Claims”,
      “fr_FR”: “Prestations et demandes d'indemnisation”
    },
    “synonyms”: [
      “Natural”
    ]
  },....
```

Taxonomy terms are used to describe, in a more organized way, complex properties of entities. For any entity, multiple taxonomy terms can be grouped by the attribute facet_name shown in line 5 as a collection of attributes.

Table 5 below shows attributes, including complex attributes.

TABLE 5

```
“attributes”: [
{
  “id”: 83,
  “name”: “pH”,
  “name_all_locales”: {
    “en_US”: “pH”,
    “fr_FR”: “pH”
  },
  “slug”: “ph”,
  “kind”: “range”,
  “text_value”: “5~7”,
  “value_boolean”: null,
  “range_begin”: “5”,
  “range_end”: “7”
},
  {
    “id”: 82,
    “name”: “Specific Gravity”,
    “slug”: “specific-gravity”,
    “kind”: “range”,
    “text_value”: “0. 945~0.96”,
    “value_boolean”: null,
    “range_begin”: “0.945”,
    “range_end”: “0.96”
  },
```

In the example of entity attributes shown above in Table 5, example attributes relate to the pH range of the product to which the entity corresponds (lines 2-15), and the specific gravity range of that product (lines 16-25).

In some embodiments, the facility performs an ingestion process in which it transforms data in the forms shown and described above to a format that is optimized for searching purposes. In some embodiments, this involves grouping taxonomy terms, connecting them with synonyms, and storing them as a collection of terms. In some embodiments, complex attributes are converted to enable using them as filters, while simple attributes are stored as simple attributes.

In some embodiments, this ingestion process produces a document, an example of which is shown below in Table 6.

TABLE 6

```
  “id” : 427106,
  “company_id” : 4348,
  “brand_id” : 34023,
  “name” : “NATIVE TAPIOCA STARCH ”,
  “long_description” : “NATIVE TAPIOCA STARCH is a
    microbiological food (MF) grade starch
    primarily intended for use in food
    products. It appears as a white powder
    with a negligible odor. The product is
    manufactured in compliance with all
    provisions of the Toxic Substances
    Control Act (TSCA).”,
  “fr~name” : “AMIDON DE TAPIOCA NATIF”,
  “fr~long_description” : “L'amidon de TAPIOCA NATIF est un
    amidon de qualité alimentaire
    microbiologique (MF) principalement
    destiné à être utilisé dans les
    produits alimentaires. Il se présente
    sous la forme d'une poudre blanche à
    l'odeur négligeable. Le produit est
    fabriqué en conformité avec toutes les
    dispositions du Toxic Substances
    Control Act (TSCA).”,
“tt labeling claims” : [
  “Naturally Derived”,
  “Halal”,
  “Kosher”,
  “Natural”,
  “Plant-Based”
],
“fr~tt_labeling_claims” : [
  “Naturel”,
  “À base de plantes”,
  “'origine naturelle”,
  “Cachère”,
  “Halal”
  ],
“range_ph” : {
  “gte” : 5.0,
  “lte” : 7.0
  },
```

The relationship between the data shown above in Table 6 and the data from which it was transformed shown in Tables 1-3 is generally clear. Lines 24-30 show taxonomy terms for the entity, while lines 38-41 show an example of a complex attribute, a range that spans from 5.0 to 7.0, inclusive. In some embodiments, the facility stores a less human-readable, more actionable version of the document shown in Table 6.

In some embodiments, each field in the search index can contain multiple definitions for use in searching. Each definition is related to what is stored in a particular field. Simple text sometimes has a different definition than a number field. Fields with text in different languages in some embodiments have different definitions as well, because of differences in the grammars that apply to those languages. Table 7 below shows examples of definitions applied to terms.

TABLE 7

```
“name” : {
“type” : “keyword”,
“fields” : {
“concept” : {
  “type” : “text”,
  “analyzer” : “english-standard-concept-analyzer”
},
“keyword” : {
  “type” : “keyword”
},
“shingle” : {
  “type” : “text”,
  “analyzer” : “english-standard-shingle-analyzer”
},
“text” : {
  “type” : “text”,
  “index_options” : “docs”,
  “norms” : false,
  “analyzer” : “english-standard-text-analyzer”
},
“typeahead” : {
  “type” : “text”,
  “analyzer” : “english-standard-typeahead-text-analyzer”
}
},
“fr~name” : {
“type” : “keyword”,
“fields” : {
“concept” : {
  “type” : “text”,
  “analyzer” : “french-standard-concept-analyzer”
},
“keyword” : {
  “type” : “keyword”
},
“shingle” : {
  “type” : “text”,
  “analyzer” : “french-standard-shingle-analyzer”
},
“text” : {
  “type” : “text”,
  “index_options” : “docs”,
  “norms” : false,
  “analyzer” : “french-standard-text-analyzer”
},
“typeahead” : {
  “type” : “text”,
  “analyzer” : “french-standard-typeahead-text-analyzer”
}
}
```

In some embodiments, concepts are a general idea that represents a group or category of related terms or entities. In some embodiments, the facility represents such groups by taxonomy terms, entity classifications, and elements of entity descriptions. Concept terms included in Table 7 above include “kosher,” “naturally derived,” “a base plant,” and “native tapioca starch.” In some embodiments, when extracting concepts from particular entities, the facility stores in connection with the concept phrase additional information that assists in optimizing query plan graphs for execution by the search engine. For example, Table 8 below shows the extraction of the phrase “a base plant” from the tt_labeling_claims.concept field.

TABLE 8

“field” : “tt_labeling_claims.concept”,
“type” : “ORIGINAL”,
“fr~953effff-9fca-43a8-9364-0257d2003e67~searchTerms” : [
“a base plant”
],
“fr~953effff-9fca-43a8-9364-0257d2003e67~originalTerm” : “a
base plant”
}

Table 9 below shows a suffix concept for the tt_labeling_claims.concept.

TABLE 9

```
“fr~tt_labeling_claims” : {
“type” : “text”,
“fields” : {
“concept” : {
  “type” : “text”,
  “analyzer” : “french-standard-concept-analyzer”
},
“keyword” : {
  “type” : “keyword”
},
“shingle” : {
  “type” : “text”,
  “analyzer” : “french-standard-shingle-analyzer”
},
“text” : {
  “type” : “text”,
  “index_options” : “docs”,
  “norms” : false,
  “analyzer” : “french-standard-text-analyzer”
}
}
}
```

Lines 4-6 are responsible for extracting and storing information from the example as shown in the preceding tables.

In some embodiments, the facility performs pre-processing on each received user query. This pre-processing can include removing elements irrelevant to searching, such as stop words, punctuation marks, special characters, or extra alphabet characters. In some embodiments, pre-processing also includes breaking down each phrase into its constituent elements, i.e., tokens. Each token contains information about its place in the search phrase and its type, such as text, number, unit of measurement, CAS number, etc.

Table 10 below contains the tokens obtained by the facility from the query term “35-66-5 Benzacridine (9CI).”

TABLE 10

{
“token” : “35-66-5”,
“start_offset” : 0,
“end_offset” : 7,
“type” : “<CAS_NO>”,
“position” : 0
},
{
“token” : “benzacridine”,
“start_offset” : 8,
“end_offset” : 20,
“type” : “<ALPHANUM>”,
“position” : 1
},
{
“token” : “9ci”,
“start_offset” : 22,
“end_offset” : 25,
“type” : “<ALPHANUM>”,
“position” : 2
}

Lines 1-7 show the recognition of the substring “35-66-5” as a CAS number. Lines 8-14 show the recognition of the substring “benzacridine” as alphanumeric. And lines 15-21 show the recognition of the substring “(9ci)” as alphanumeric.

Table 11 below shows an additional example of recognition of tokens from a sample query term “the high density of polyethylene hdpe”.

TABLE 11

{
“token” : “high”,
“start_offset” : 4,
“end_offset” : 8,
“type” : “<ALPHANUM>”,
“position” : 0
},
{
“token” : “density”,
“start_offset” : 9,
“end_offset” : 16,
“type” : “<ALPHANUM>”,
“position” : 1
},
{
“token” : “polyethylene”,
“start_offset” : 20,
“end_offset” : 32,
“type” : “<ALPHANUM>”,
“position” : 2
},
{
“token” : “hdpe”,
“start_offset” : 33,
“end_offset” : 37,
“type” : “<ALPHANUM>”,
“position” : 3
}

Table 11 above shows the recognition of significant alphanumeric tokens of the query phrase, and the removal of irrelevant elements (“the” and “of”).

To generate a query from the facility's tokenization of a phrase as shown in Tables 8 and 9, the facility analyzes each token in relation to the other tokens and to the search term itself to generate a list of potential concepts from the search phrase. In some cases, this list of potential concepts may contain some that later prove to be irrelevant. Table 12 below shows potential concepts determined by the facility from the query term “black resin containing PIR and nylon”.

TABLE 12

```
  [
  {
    “startPosition”: 0,
    “endPosition”: 1,
    “originalSubphrase”: “black”,
    “analyzedUserSubphrase”: “black”,
    “length”: 1
  },
  {
    “startPosition”: 0,
    “endPosition”: 2,
    “originalSubphrase”: “black resin”,
    “analyzedUserSubphrase”: “black resin”,
    “length”: 2
  },
  {
    “startPosition”: 0,
    “endPosition”: 3,
    “originalSubphrase”: “black resin containing”,
    “analyzedUserSubphrase”: “black resin containing”,
    “length”: 3
  },
  {
    “startPosition”: 0,
    “endPosition”: 4,
    “originalSubphrase”: “black resin containing PIR”,
    “analyzedUserSubphrase”: “black resin containing pir”,
    “length”: 4
  },
  {
    “startPosition”: 0,
    “endPosition”: 5,
    “originalSubphrase”: “black resin containing PIR and nylon”,
    “analyzedUserSubphrase”: “black resin containing pir nylon”,
    “length”: 5
  },
  {
    “startPosition”: 1,
    “endPosition”: 2,
    “originalSubphrase”: “resin”,
    “analyzedUserSubphrase”: “resin”,
    “length”: 1
  },
  {
    “startPosition”: 1,
    “endPosition”: 3,
    “originalSubphrase”: “resin containing”,
    “analyzedUserSubphrase”: “resin containing”,
    “length”: 2
  },
  {
    “startPosition”: 1,
    “endPosition”: 4,
    “originalSubphrase”: “resin containing PIR”,
    “analyzedUserSubphrase”: “resin containing pir”,
    “length”: 3
  },
  {
    “startPosition”: 1,
    “endPosition”: 5,
    “originalSubphrase”: “resin containing PIR and nylon”,
    “analyzedUserSubphrase”: “resin containing pir nylon”,
    “length”: 4
  },
  {
    “startPosition”: 2,
    “endPosition”: 3,
    “originalSubphrase”: “containing”,
    “analyzedUserSubphrase”: “containing”,
    “length”: 1
  },
  {
    “startPosition”: 2,
    “endPosition”: 4,
    “originalSubphrase”: “containing PIR”,
    “analyzedUserSubphrase”: “containing pir”,
    “length”: 2
  },
  {
    “startPosition”: 2,
    “endPosition”: 5,
    “originalSubphrase”: “containing PIR and nylon”,
    “analyzedUserSubphrase”: “containing pir nylon”,
    “length”: 3
  },
  {
    “startPosition”: 3,
    “endPosition”: 4,
    “originalSubphrase”: “PIR”,
    “analyzedUserSubphrase”: “pir”,
    “length”: 1
  },
  {
    “startPosition”: 3,
    “endPosition”: 5,
    “originalSubphrase”: “PIR and nylon”,
    “analyzedUserSubphrase”: “pir nylon”,
    “length”: 2
  },
  {
    “startPosition”: 4,
    “endPosition”: 5,
    “originalSubphrase”: “nylon”,
    “analyzedUserSubphrase”: “nylon”,
    “length”: 1
  }
]
```

The facility verifies a list of potential concepts like the example shown above in Table 12 against a concepts search index, in some cases using a term matcher or a regular expression matcher. In some embodiments, the facility's selection of regular expression match or full term match is based on the length of the concept and/or the position of the concept in the search term that contains it.

Tables 11 and 12 below show examples of queries used to verify the potential concepts “high” and “high density polyethylene”.

TABLE 13

```
{
  “query”: {
    “bool”: {
      “must”: [
        {
          “regexp”: {
            “searchTerms”: {
              “value”: “r ?e ?s ?i ?n”,
              “flags_value”: 255,
              “max_determinized_states”: 10000,
              “boost”: 1.0
            }
          }
        }
      ],
      “adjust_pure_negative”: true,
      “boost”: 1.0
    }
  }
}
```

TABLE 14

```
{
  “query”: {
    “bool”: {
      “must”: [
        {
          “term”: {
            “searchTerms”: {
              “value”: “black resin containing pir”,
              “boost”: 1.0
            }
          }
        }
      ],
      “adjust_pure_negative”: true,
      “boost”: 1.0
    }
  }
}
```

Table 15 below shows a sample list of concepts verified by the facility. This list of verified contents contains additional information such as concept type, the identity of the field that contains it, and how it was extracted. In some embodiments, unrecognized potential concepts that could not be verified are used at a later time to find matches using partial matching.

```
TABLE 15
[
  {
    “startPosition”: 0,
    “endPosition”: 1,
    “type”: “ORIGINAL”,
    “originalSubphrase”: “black”,
    “analyzedUserSubphrase”: “black”,
    “recognizedProductToken”: “black”,
    “fields”: [
      {
        “fieldName”: “grade_name.text”,
        “originalFieldName”: “grade_name”.
        “weight”: 0.0,
        “analysis”: “text”,
        “mandatory”: false,
        “localizedFieldName”: “grade_name.text”
      },
      {
        “fieldName”: “name.text”,
        “originalFieldName”: “name”,
        “weight”: 0.0,
        “analysis”: “text”,
        “mandatory”: false,
        “localizedFieldName”: “name.text”
      },
      {
        “fieldName”: “tt_color.concept”
        “originalFieldName”: “tt_color”,
        “weight”: 0.0,
        “analysis”: “concept”,
        “mandatory”: false,
        “localizedFieldName”: “tt_color.concept”
      },
      {
        “fieldName”: “long_description.text”,
        “originalFieldName”: “long_description”,
        “weight”: 0.0,
        “analysis”: “text”,
        “mandatory”: false,
        “localizedFieldName”: “long_description.text”
      }
    ],
    “penalty”: 0.0,
    “restricted”: false,
    “length”: 1
  },
  {
    “startPosition”: 0,
    “endPosition”: 2,
    “type”: “UNRECOGNIZED”,
    “originalSubphrase”: “black resin”,
    “analyzedUserSubphrase”: “black resin”,
    “fields”: [ ],
    “penalty”: 0.0,
    “restricted”: false,
    “length”: 2
  },
  {
    “startPosition”: 0,
    “endPosition”: 3,
    “type”: “UNRECOGNIZED”,
    “originalSubphrase”: “black resin containing”,
    “analyzedUserSubphrase”: “black resin containing”,
    “fields”: [ ],
    “penalty”: 0.0,
    “restricted”: false,
    “length”: 3
  },
  {
    “startPosition”: 0,
    “endPosition”: 4,
    “type”: “UNRECOGNIZED”,
    “originalSubphrase”: “black resin containing PIR”,
    “analyzedUserSubphrase”: “black resin containing pir”,
    “fields”: [ ],
    “penalty”: 0.0,
    “restricted”: false,
    “length”: 4
  },
  {
    “startPosition”: 0,
    “endPosition”: 5,
    “type”: “UNRECOGNIZED”,
    “originalSubphrase”: “black resin containing PIR and nylon”,
    “analyzedUserSubphrase”: “black resin containing pir nylon”,
    “fields”: [ ],
    “penalty”: 0.0,
    “restricted”: false,
    “length”: 5
  },
  {
    “startPosition”: 1,
    “endPosition”: 2,
    “type”: “ORIGINAL”,
    “originalSubphrase”: “resin”,
    “analyzedUserSubphrase”: “resin”,
    “recognizedProductToken”: “resin”,
    “fields”: [
      {
        “fieldName”: “tt_labeling_claims.text”,
        “originalFieldName”: “tt_labeling_claims”,
        “weight”: 0.0,
        “analysis”: “text”,
        “mandatory”: false,
        “localizedFieldName”: “tt_labeling_claims.text”
      },
      {
        “fieldName”: “tt_plastics_&_elastomers_functions.concept”,
        “originalFieldName”: “tt_plastics_&_elastomers_functions”,
        “weight”: 0.0,
        “analysis”: “concept”,
        “mandatory”: false,
        “localizedFieldName”:
          “tt_plastics_&_elastomers_functions.con
          cept”
      },
      {
        “fieldName”: “synonyms.text”,
        “originalFieldName”: “synonyms”,
        “weight”: 0.0,
        “analysis”: “text”,
        “mandatory”: false,
        “localizedFieldName”: “synonyms.text”
      },
      {
        “fieldName”: “long_description.text”,
        “originalFieldName”: “long_description”,
        “weight”: 0.0,
        “analysis”: “text”,
        “mandatory”: false,
        “localizedFieldName”: “long_description.text”
      }
    ],
    “penalty”: 0.0,
    “restricted”: false,
    “length”: 1
  },
  {
    “startPosition”: 1,
    “endPosition”: 3,
    “type”: “UNRECOGNIZED”,
    “originalSubphrase”: “resin containing”,
    “analyzedUserSubphrase”: “resin containing”,
    “fields”: [ ],
    “penalty”: 0.0,
    “restricted”: false,
    “length”: 2
  },
  {
    “startPosition”: 1,
    “endPosition”: 4,
    “type”: “UNRECOGNIZED”,
    “originalSubphrase”: “resin containing PIR”,
    “analyzedUserSubphrase”: “resin containing pir”,
    “fields”: [ ],
    “penalty”: 0.0,
    “restricted”: false,
    “length”: 3
  },
  {
    “startPosition”: 1,
    “endPosition”: 5,
    “type”: “UNRECOGNIZED”,
    “originalSubphrase”: “resin containing PIR and nylon”,
    “analyzedUserSubphrase”: “resin containing pir nylon”,
    “fields”: [ ],
    “penalty”: 0.0,
    “restricted”: false,
    “length”: 4
  },
  {
    “startPosition”: 2,
    “endPosition”: 3,
    “type”: “UNRECOGNIZED”,
    “originalSubphrase”: “containing”,
    “analyzedUserSubphrase”: “containing”,
    “fields”: [ ],
    “penalty”: 0.0,
    “restricted”: false,
    “length”: 1
  },
  {
    “startPosition”: 2,
    “endPosition”: 4,
    “type”: “UNRECOGNIZED”,
    “originalSubphrase”: “containing PIR”,
    “analyzedUserSubphrase”: “containing pir”,
    “fields”: [ ],
    “penalty”: 0.0,
    “restricted”: false,
    “length”: 2
  },
  {
    “startPosition”: 2,
    “endPosition”: 5,
    “type”: “UNRECOGNIZED”,
    “originalSubphrase”: “containing PIR and nylon”,
    “analyzedUserSubphrase”: “containing pir nylon”,
    “fields”: [ ],
    “penalty”: 0.0,
    “restricted”: false,
    “length”: 3
  },
  {
    “startPosition”: 3,
    “endPosition”: 4,
    “type”: “ORIGINAL”,
    “originalSubphrase”: “PIR”,
    “analyzedUserSubphrase”: “pir”,
    “recognizedProductToken”: “pir”,
    “fields”: [
      {
        “fieldName”: “tt_labeling_claims.text”,
        “originalFieldName”: “tt_labeling_claims”,
        “weight”: 0.0,
        “analysis”: “text”,
        “mandatory”: false,
        “localizedFieldName”: “tt_labeling_claims.text”
      }
    ],
    “penalty”: 0.0,
    “restricted”: false,
    “length”: 1
  },
  {
    “startPosition”: 3,
    “endPosition”: 5,
    “type”: “UNRECOGNIZED”,
    “originalSubphrase”: “PIR and nylon”,
    “analyzedUserSubphrase”: “pir nylon”,
    “fields”: [ ],
    “penalty”: 0.0,
    “restricted”: false,
    “length”: 2
  },
  {
    “startPosition”: 4,
    “endPosition”: 5,
    “type”: “UNRECOGNIZED”,
    “originalSubphrase”: “nylon”,
    “analyzedUserSubphrase”: “nylon”,
    “fields”: [ ],
    “penalty”: 0.0,
    “restricted”: false,
    “length”: 1
  }
]
```

In some embodiments, the facility applies a spell correction algorithm to any unrecognized concepts contained by the verified concepts list, seeking to find matches using fuzzy query matching; these are included in the concept list for future use.

Table 16 below shows a sample final concepts list obtained by the facility by removing from the verified concept list shown in Table 13 unrecognized shingles.

```
TABLE 16
  [
  {
    “startPosition”: 0,
    “endPosition”: 1,
    “type”: “ORIGINAL”,
    “originalSubphrase”: “black”,
    “analyzedUserSubphrase”: “black”,
    “recognizedProductToken”: “black”,
    “fields”: [
      {
        “fieldName”: “grade_name.text”,
        “originalFieldName”: “grade_name”,
        “weight”: 0.0,
        “analysis”: “text”,
        “mandatory”: false,
        “localizedFieldName”: “grade_name.text”
      },
      {
        “fieldName”: “name.text”,
        “originalFieldName”: “name”,
        “weight”: 0.0,
        “analysis”: “text”,
        “mandatory”: false,
        “localizedFieldName”: “name.text”
      },
      {
        “fieldName”: “tt_color.concept”,
        “originalFieldName”: “tt_color”,
        “weight”: 0.0,
        “analysis”: “concept”,
        “mandatory”: false,
        “localizedFieldName”: “tt_color.concept”
      },
      {
        “fieldName”: “long_description.text”,
        “originalFieldName”: “long_description”,
        “weight”: 0.0,
        “analysis”: “text”,
        “mandatory”: false,
        “localizedFieldName”: “long_description.text”
      }
    ],
    “penalty”: 0.0,
    “restricted”: false,
    “length”: 1,
    “mandatory”: false,
    “spellCorrected”: false
  },
  {
    “startPosition”: 2,
    “endPosition”: 3,
    “type”: “UNRECOGNIZED”,
    “originalSubphrase”: “containing”,
    “analyzedUserSubphrase”: “containing”,
    “fields”: [ ],
    “penalty”: 0.0,
    “restricted”: false,
    “length”: 1,
    “mandatory”: false,
    “spellCorrected”: false
  },
  {
    “startPosition”: 4,
    “endPosition”: 5,
    “type”: “UNRECOGNIZED”,
    “originalSubphrase”: “nylon”,
    “analyzedUserSubphrase”: “nylon”,
    “fields”: [ ],
    “penalty”: 0.0,
    “restricted”: false,
    “length”: 1,
    “mandatory”: false,
    “spellCorrected”: false
  },
  {
    “startPosition”: 1,
    “endPosition”: 2,
    “type”: “ORIGINAL”,
    “originalSubphrase”: “resin”,
    “analyzedUserSubphrase”: “resin”,
    “recognizedProductToken”: “resin”,
    “fields”: [
      {
        “fieldName”: “tt_labeling_claims.text”,
        “originalFieldName”: “tt_labeling_claims”,
        “weight”: 0.0,
        “analysis”: “text”,
        “mandatory”: false,
        “localizedFieldName”: “tt_labeling_claims.text”
      },
      {
        “fieldName”: “tt_plastics_&_elastomers_functions.concept”,
        “originalFieldName”: “tt_plastics_&_elastomers_functions”,
        “weight”: 0.0,
        “analysis”: “concept”,
        “mandatory”: false,
        “localizedFieldName”:
          “tt_plastics_&_elastomers_functions.con
          cept”
      },
      {
        “fieldName”: “synonyms.text”,
        “originalFieldName”: “synonyms”,
        “weight”: 0.0,
        “analysis”: “text”,
        “mandatory”: false,
        “localizedFieldName”: “synonyms.text”
      },
      {
        “fieldName”: “long_description.text”,
        “originalFieldName”: “long_description”,
        “weight”: 0.0,
        “analysis”: “text”,
        “mandatory”: false,
        “localizedFieldName”: “long_description.text”
      }
    ],
    “penalty”: 0.0,
    “restricted”: false,
    “length”: 1,
    “mandatory”: false,
    “spellCorrected”: false
  },
  {
    “startPosition”: 3,
    “endPosition”: 4,
    “type”: “ORIGINAL”,
    “originalSubphrase”: “PIR”,
    “analyzedUserSubphrase”: “pir”,
    “recognizedProductToken”: “pir”,
    “fields”: [
      {
        “fieldName”: “tt_labeling_claims.text”,
        “originalFieldName”: “tt_labeling_claims”,
        “weight”: 0.0,
        “analysis”: “text”,
        “mandatory”: false,
        “localizedFieldName”: “tt_labeling_claims.text”
      }
    ],
    “penalty”: 0.0,
    “restricted”: false,
    “length”: 1,
    “mandatory”: false,
    “spellCorrected”: false
  }
]
```

In some embodiments, the facility performs stage search on the final concepts list it produces, such as the example shown above in Table 16. The facility's stage search seeks to determine which of the concepts in the finalized concepts set are valuable for the query, i.e., those concepts that are the most relevant to resolving the query.

A sample series of four searching stages is shown below in Table 17.

TABLE 17

```
{
  “elasticsearch_params” : {
    “max_edits” : 2,
    “prefix_length” : 1,
    “min_word_length” : 3,
    “string_distance” : “WEIGHTED_DAMERAU_LEVENSHTEIN”,
    “number_of_spell_suggestions”: 100,
    “spell_check_limit” : 5000
  },
  “default_search_profile”: “search_profile1”,
  “search_profiles”: {
    “search_profile1”:
      {
        “searchable_field_sets”: [
          {
            “name”: “product_type”,
            “type”: “EXACT”,
            “excludedFields”: [ ],
            “excludedFieldsRegex”: [ ],
            “fieldsRegex”: [ ],
            “fields”: [
              { “field”: “tt_knowde_categories.concept”, “type” :
                “category”, “mandatory” : true,
                “weight” : 99 },
              { “field”: “inci-names.concept”, “type” : “product”,
                “mandatory” : true, “weight” : 100 },
              { “field”: “tt_plastics_&_elastomers_functions.concept”,
                “type” : “product”, “mandatory” : true,
                “weight”:100 },
              { “field”: “tt_textile_chemicals_function.concept”,
                “type” : “product”, “mandatory” : true,
                “weight”:100 },
              { “field”: “tt_applicable_processes.concept”, “type”:
                “descriptor”, “weight”: 80}
            ],
            “requiredConceptCount”: {
              “gte”: 1,
              “lte”: 1
            }
          },
          {
            “name” : “exact_match”,
            “type” : “EXACT”,
            “extends”: “product_type”,
            “excludedFields”: [ ],
            “excludedFieldsRegex”: [ ],
            “fields” : [
                { “field”: “cas-number.concept”, “type” : “product”,
                “mandatory” : true, “weight”: 100},
              { “field”: “ec-number.concept”, “type” : “product”,
                “mandatory” : true, “weight”: 100},
              { “field”: “company_name.concept”, “type”
                “storefront”, “weight” : 100 },
              { “field”: “company_name.shingle”, “weight” : 50 },
              { “field”: “company_name.text”, “weight” : 30 },
              { “field”: “tt_knowde_categories.shingle”, “weight” : 50
                },
              { “field”: “inci-names.shingle”, “weight” : 50 },
              { “field”: “name.concept”, “type” : “descriptor”,
                “weight” : 100 },
              { “field”: “name.shingle”, “weight”: 50},
              { “field”: “name.text”, “weight”: 30},
              { “field”: “tt_flavor.concept”, “type”: “descriptor”,
                “weight”: 85}
            ],
            “fieldsRegex”: [
              { “pattern”: “attr_.*concept”, “type” : “descriptor”,
                “weight”: 60},
              { “pattern”: “tt_.*concept”, “type” : “descriptor”,
                “weight”: 80},
              { “pattern”: “attr_.*.shingle”, “weight”: 50} ,
              { “pattern”: “tt_.*.shingle”, “weight” : 60}
            ]
          },
          {
            “name” : “text_match”,
            “type” : “EXACT”,
            “extends”: “exact_match”,
            “excludedFields”: [ ],
            “excludedFieldsRegex”: [ ],
            “fields” : [
              { “field”: “tt_knowde_categories.text”, “weight” : 30 },
              { “field”: “tt_flavor_type.concept”, “type”:
                “descriptor”, “weight”: 85},
              { “field”: “tt_flavor.concept”, “type”: “descriptor”,
                “weight”: 85}
            ],
            “fieldsRegex”: [
              { “pattern”: “attr_.*.text”, “weight” : 30},
              { “pattern”: “tt_.*.text”, “weight” : 30}
            ]
          },
          {
            “name” : “partial_match”,
            “type” : “PARTIAL”,
            “extends”: “text_match”,
            “minimumShouldMatch”: 0.5,
            “excludedFields”: [ ],
            “excludedFieldsRegex”: [ ],
            “fields” : [ ],
            “fieldsRegex”: [
              { “pattern”: “attr_.*.shingle”, “weight” : 60},
              { “pattern”: “tt_.*.shingle”, “weight” : 50},
              { “pattern”: “attr_.*.text”, “weight” : 30}
              { “pattern”: “tt_.*.text”, “weight” : 30}
            ]
          }
        ]
      }
  }
}
```

Lines 1-9 contain configuration elements, which configure behavior for searching using this entire series of stages. For example, line 6 specifies a particular spell correction algorithm to use, and lines 7 and 8 parameters to be passed to this spell correction algorithm.

Lines 10 and 11 define the searching profile to which the series of four searching stages shown in Table 17 relate as the default searching profile—i.e., the searching profile that should be used if there is no basis for choosing a different searching profile for processing a user query.

The four searching stages specified in Table 17 are as follows: product_type stage (lines 15-40); exact_match stage (lines 41-74); text_match stage (lines 75-92); and partial_match stage (lines 93-107).

For example, the first, product_type stage has the following characteristics: line 17 specifies that an exact match is required for this stage. Lines 21-35 specify the five fields to be matched in this stage, e.g., the tt_knowde_categories.concept field specified in lines 22-24. These lines further specify that the type of this field “category”, this field is mandatory to match, and this field is assigned a weight of 99.

Lines 36-38 specify that if exactly one concept from the query matches any of the five specified fields, then this first stage succeeds and the query plan graph it produces will be executed by the facility to generate the search result for the query.

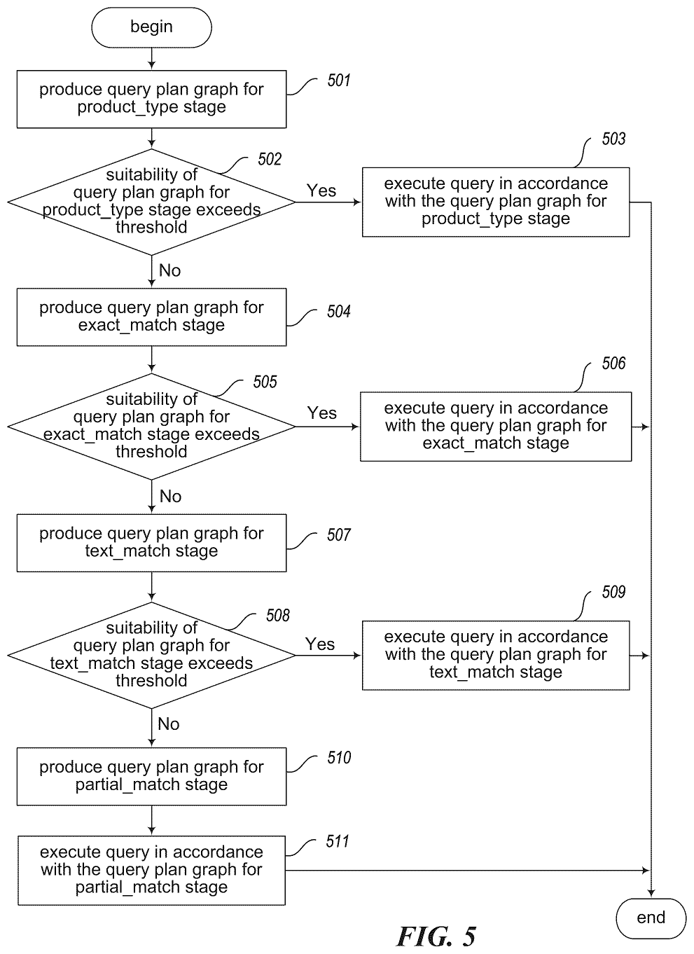

FIG. 5 is a flow diagram showing the searching process performed by the facility based upon the example definition of searching stages shown in Table 17. In act 501, the facility produces a query plan graph for the product_type stage. In act 502, if the suitability of the query plan graph produced in act 501 exceeds a suitability threshold, then the facility continues in act 503, else the facility continues in act 504. In act 503, the facility executes the query in accordance with the query plan graph produced for the product_type stage. After act 503, this process concludes.

In act 504, the facility produces a query plan graph for the exact_match stage. In act 505, if the suitability of the query plan graph produced in act 504 for the exact_match stage exceeds the threshold, then the facility continues in act 506, else the facility continues in act 507. In act 506, the facility executes the query in accordance with the query plan graph for the exact_match stage. After act 506, this process concludes.

In act 507, the facility produces a query plan graph for the text_match stage. In act 508, if the suitability of the query plan graph produced in act 507 for the text_match stage exceeds the threshold, then the facility continues in act 509, else the facility continues in act 510. In act 509, the facility executes the facility in accordance with the query plan graph for the text_match stage. After act 509, this process concludes.

In act 510, the facility produces a query plan graph for the partial_match stage. In act 511, the facility executes the query in accordance with the query plan graph for the partial_match stage. After act 511, this process concludes.

In each stage, the facility extracts concepts from the fields specified for the stage. Table 18 below shows the concept list obtained by the facility by applying the first stage specified in 15.

```
TABLE 18
[
  {
    “startPosition”: 2,
    “endPosition”: 3,
    “type”: “UNRECOGNIZED”,
    “originalSubphrase”: “containing”,
    “analyzedUserSubphrase”: “containing”,
    “fields”: [ ],
    “penalty”: 1.0,
    “restricted”: false,
    “length”: 1,
    “mandatory”: false,
    “spellCorrected”: false
  },
  {
    “startPosition”: 4,
    “endPosition”: 5,
    “type”: “UNRECOGNIZED”,
    “originalSubphrase”: “nylon”,
    “analyzedUserSubphrase”: “nylon”,
    “fields”: [ ],
    “penalty”: 1.0,
    “restricted”: false,
    “length”: 1,
    “mandatory”: false,
    “spellCorrected”: false
  },
  {
    “startPosition”: 1,
    “endPosition”: 2,
    “type”: “ORIGINAL”,
    “originalSubphrase”: “resin”,
    “analyzedUserSubphrase”: “resin”,
    “recognizedProductToken”: “resin”,
    “fields”: [
      {
        “fieldName”: “tt_plastics_&_elastomers_functions.concept”,
        “originalFieldName”: “tt_plastics_&_elastomers_functions”,
        “weight”: 100.0,
        “analysis”: “concept”,
        “mandatory”: true,
        “localizedFieldName” :
          “tt_plastics_&_elastomers_functions.con
          cept”
      }
    ],
    “penalty”: 1.0,
    “restricted”: false,
    “length”: 1,
    “mandatory”: true,
    “spellCorrected”: false
  }
]
```

While Table 18 contains a number of unrecognized concepts not mapped to fields specified by the first stage, lines 28-45 show the matching of the concept “resin” to the “field tt_plastics_&_elastomers_functions”.concept, specified for the first stage in lines 27-29 of Table 17.

The facility next verifies the relationship of the matched concepts to the original phrase. To facilitate this analysis, a graph is created representing this relationship. Each edge of the graph represents a relation between tokens in the original phrase and matched concepts.

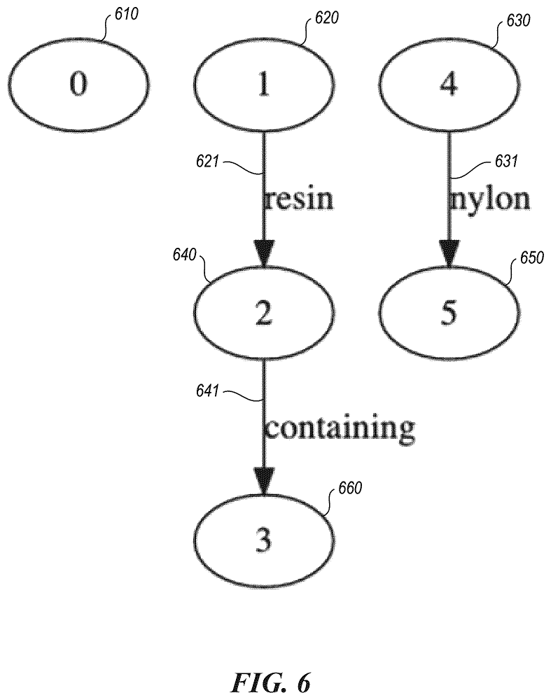

FIG. 6 is a graph diagram showing a sample graph relating query tokens and matched concepts. The graph has six nodes, nodes 610, 620, 630, 640, 650, and 660, each representing one of the tokens from the user query “black resin containing PIR and nylon”. For example, node 610 represents the token “black”, node 620 the token “resin”, and so forth. Edge 621 represents the concept “resin”; edge 641 represents the concept “containing”; and edge 631 represents the concept “nylon”.

The graph makes it easier to identify edges that connect the first and last nodes of the graph, enabling the facility to determine which of the matched concepts has the best match in relation to the original user query. The graph shown in FIG. 6 represents the situation in which a search is not matched fully, and only a partial match can be applied.

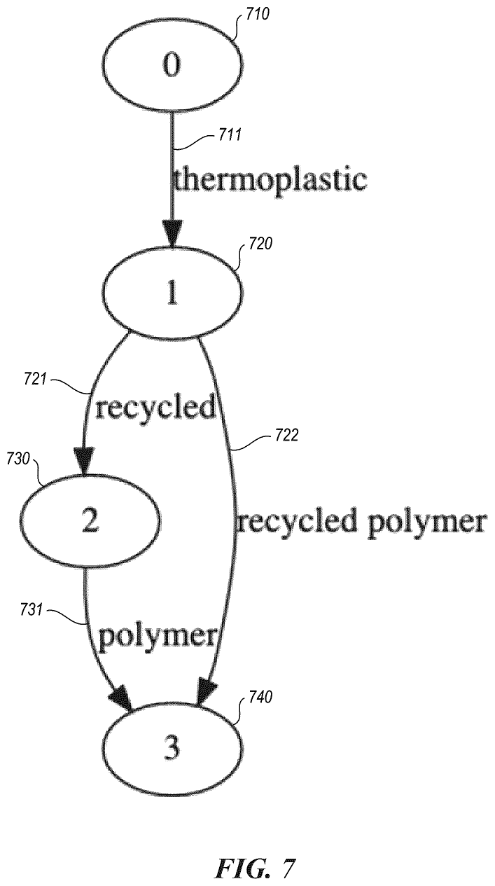

FIG. 7 is a graph diagram showing a sample concept matching graph in which the matched concepts fully correspond to the tokens of the user query. This graph represents the user query “thermoplastic recycled polymers”. It is made up of nodes 710, 720, 730, and 740, and edges 711, 721, 722, and 731. The graph shows two paths from starting node 710 to ending node 740. The first path is through nodes 720 and 730, and represents the concept sequence “thermoplastic”+“recycled”+“polymer”. The second path through intermediate node 720 represents the concept sequence “thermoplastic”+“recycled polymer”.

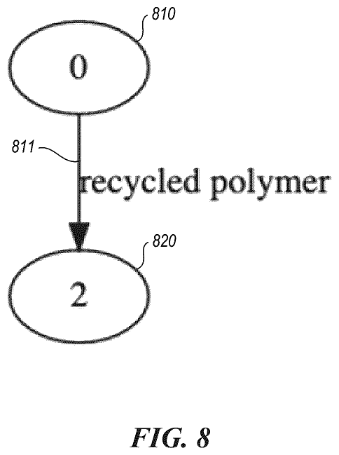

In some embodiments, the graph is used to verify that stage pre-conditions are met, such as the facility should continue to verify the concepts. For example, lines 36-38 of Table 17 specify that, for the first stage, the facility must obtain a graph containing a path from the first node to the last node of length 1. FIG. 8 is a graph diagram showing a sample graph relating fields and concepts that satisfies this requirement.

Table 19 below shows a query structure corresponding to the sample graph shown in FIG. 6 that the facility calls the search engine to execute.

TABLE 19

```
{
  “bool”: {
    “must”: [
    {
      “dis_max”: {
      “tie_breaker”: 0.0,
      “queries”: [
      {
        “bool”: {
          “must”: [
          {
            “dis_max”: {
            “tie_breaker”: 0.0,
            “queries”: [
            {
              “explainTerm”: {
                “tt_knowde_categories.concept”: “recycled
                  polymer”,
                “path”: 1,
                “edge”: 1,
                “start”: 0,
                “end”: 2,
                “boost”: 198.0
              }
            }
            ]
            }
          }
          ]
        }
      }
      ]
      }
    }
    ]
  }
}
```

In particular, lines 17 and 18 of Table 19 specify that the concept “recycled polymer” is to be matched against the field tt_knowde_categories.concept. The query further contains the structure of the graph in lines 19-22. The query further includes a boost factor of 198.0 in line 23, obtained by multiplying the weight of 99 specified in line 24 of Table 17 for the field tt_knowde_categories.concept by 2, the number of words in the concept.

A reorganized version of the query shown in Table 19 that is submitted to evaluate the fitness of the searching graph is shown below in Table 20.

TABLE 20

```
[
  {
    “paths”: {
    “1”: {
      “termExplains”: [
      {
      “term”: “recycled polymer”,
      “originalTerm”: “Recycled Polymers”,
      “field”: “tt_knowde_categories”,
      “boost”: 198,
      “startPosition”: 0,
      “endPosition”: 2,
      “type”: “concept”,
      “conceptType”: “ORIGINAL”
      }
      ],
      “phrase”: “Recycled Polymers”
    }
    },
    “docCount”: 1,
    “score”: 198,
    “docIds”: [ ]
  }
]
```

The result of submitting the preliminary query in shown above in Table 20 indicates the number of documents in which the phrase specified by the query occurs in the field specified by the query. In some embodiments, the facility uses this number to determine whether the stage completion criteria for the present stage are satisfied. If the stage completion criteria for the present stage are not satisfied, the facility progresses to the next stage within the series of stages.

Where the stage completion criteria for the present stage are satisfied, the facility proceeds to execute the searching plan graph from the present stage. The “main search” executed by the facility based upon the results produced by the current stage is shown below in Table 21.

TABLE 21

```
{
  “dis_max” : {
    “tie_breaker” : 0.0,
    “queries” : [
    {
      “constant_score” : {
      “filter” : {
      “bool” : {
        “filter” : [
          {
          “term” : {
            “tt_knowde_categories.concept” : {
            “value” : “recycled polymer”,
            “boost” : 1.0
            }
          }
          }
        ],
        “adjust_pure_negative” : true,
        “boost” : 1.0
      }
      },
      “boost” : 198.0
      }
    }
    ],
    “boost” : 1.0
    }
}
```

This “main search” is the first time that the facility identifies items, i.e., entities, that satisfy any searching plan graph. This sample query is a simple query without multiple subqueries, but in some embodiments, the facility submits a complex query having multiple subqueries. In various embodiments, this final query includes additional contents such as filters, sorting, or aggregations that are to be performed on the items identified by execution of the query.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system for searching a corpus having attributes and comprising items each in turn comprising values for attributes among the attributes of the corpus, the method comprising:
receiving a query string;
identifying concepts represented in the received query string;
accessing an ordered series of query strategy stages;
for each of the query strategy stages of the ordered series, beginning with a first strategy stage of the ordered series, until a strategy stage of the ordered series is selected:
accessing a set of attributes among the corpus's attributes specified by the query strategy stage;
performing a pre-search to determine an extent to which concepts among the identified concepts are represented among the values of the attributes of the accessed set;
based on the determined extent, determining whether the query strategy stage is satisfied;
where the query strategy stage is determined to be satisfied, selecting the query strategy stage; and
performing a search to generate a search result identifying items of the corpus having values of at least a portion of the attributes of the accessed set that each represent at least one of the identified concepts.

2. The method of claim 1, further comprising causing the generated search result to be displayed.

3. The method of claim 1 wherein, for each of the query strategy stages of the ordered series, the determining is further based on a stage satisfaction criterion of the query strategy stage.

4. The method of claim 1 wherein, for each of the query strategy stages of the ordered series, the pre-search is performed using a query strategy graph constructed based upon the query strategy stage and an index.

5. The method of claim 4 wherein the search is performed using a query strategy graph that is based on the query strategy graph constructed for the selected query strategy stage.

6. The method of claim 1, further comprising:
accessing information related to the retrieved query string;
based at least in part on the accessed information, selecting one of a plurality of searching profiles; and
selecting an ordered series of query strategy stages that corresponds to the selected searching profile,
wherein the accessed ordered series of query strategy stages is the selected ordered series of query strategy stages.

7. The method of claim 6 wherein the query string was originated by an originating user,
and wherein the accessed information is a history of query strings originated by the originating user.

8. The method of claim 6 wherein the query string was originated by an originating user,
and wherein the accessed information is a configuration setting established for the originating user.

9. The method of claim 6 wherein the received query string was originated by an originating user,
and wherein the accessed information is a history of interactions with query results generated for query strings originated by the originating user before the received query string.

10. The method of claim 6 wherein the received query string was originated by an originating user,
and wherein the accessed information is a history of browsing interactions by the originating user.

11. The method of claim 6 wherein the accessed information is an explicit designation of searching profile received in connection with the received query string.

12. One or more instances of computer-readable media collectively having contents configured to cause a computing system to perform a method for searching a corpus having attributes and comprising items each in turn comprising values for attributes among the attributes of the corpus, the method comprising:
receiving a query string;
identifying concepts represented in the received query string;
accessing an ordered series of query strategy stages;
for each of the query strategy stages of the ordered series, beginning with a first strategy stage of the ordered series, until a strategy stage of the ordered series is selected:
accessing a set of attributes among the corpus's attributes specified by the query strategy stage;
performing a pre-search to determine an extent to which concepts among the identified concepts are represented among the values of the attributes of the accessed set;
based on the determined extent, determining whether the query strategy stage is satisfied;
where the query strategy stage is determined to be satisfied, selecting the query strategy stage; and
performing a search to generate a search result identifying items of the corpus having values of at least a portion of the attributes of the accessed set that each represent at least one of the identified concepts.

13. The one or more instances of computer-readable media of claim 12 wherein, for each of the query strategy stages of the ordered series, the determining is further based on a stage satisfaction criterion of the query strategy stage.

14. The one or more instances of computer-readable media of claim 12 wherein, for each of the query strategy stages of the ordered series, the pre-search is performed using a query strategy graph constructed based upon the query strategy stage and an index.

15. The one or more instances of computer-readable media of claim 14 wherein the search is performed using a query strategy graph that is based on the query strategy graph constructed for the selected query strategy stage.

16. The one or more instances of computer-readable media of claim 12, the method further comprising:
accessing information related to the retrieved query string;
based at least in part on the accessed information, selecting one of a plurality of searching profiles; and
selecting an ordered series of query strategy stages that corresponds to the selected searching profile,
wherein the accessed ordered series of query strategy stages is the selected ordered series of query strategy stages.

17. The method of claim 16 wherein the query string was originated by an originating user,
and wherein the accessed information is (a) a history of query strings originated by the originating user, (b) a configuration setting established for the originating user, (c) a history of interactions with query results generated for query strings originated by the originating user before the received query string, (d) a history of browsing interactions by the originating user, or (e) an explicit designation of searching profile received in connection with the received query string.

18. A computing system, comprising:
one or more processors; and
one or more memories collectively having contents configured to be executed by the one or more processors to perform a method for searching a corpus having attributes and comprising items each in turn comprising values for attributes among the attributes of the corpus, the method comprising:
receiving a query string;
identifying concepts represented in the received query string;
accessing an ordered series of query strategy stages;
for each of the query strategy stages of the ordered series, beginning with a first strategy stage of the ordered series, until a strategy stage of the ordered series is selected:
accessing a set of attributes among the corpus's attributes specified by the query strategy stage;
performing a pre-search to determine an extent to which concepts among the identified concepts are represented among the values of the attributes of the accessed set;
based on the determined extent, determining whether the query strategy stage is satisfied;
where the query strategy stage is determined to be satisfied, selecting the query strategy stage; and
performing a search to generate a search result identifying items of the corpus having values of at least a portion of the attributes of the accessed set that each represent at least one of the identified concepts.

19. The computing system of claim 18 wherein, for each of the query strategy stages of the ordered series, the determining is further based on a stage satisfaction criterion of the query strategy stage.

20. The computing system of claim 18 wherein, for each of the query strategy stages of the ordered series, the pre-search is performed using a query strategy graph constructed based upon the query strategy stage and an index.

21. The computing system of claim 20 wherein the search is performed using a query strategy graph that is based on the query strategy graph constructed for the selected query strategy stage.

22. The computing system of claim 18, the method further comprising:
accessing information related to the retrieved query string;
based at least in part on the accessed information, selecting one of a plurality of searching profiles; and
selecting an ordered series of query strategy stages that corresponds to the selected searching profile,
wherein the accessed ordered series of query strategy stages is the selected ordered series of query strategy stages.

23. The computing system of claim 22 wherein the query string was originated by an originating user,
and wherein the accessed information is (a) a history of query strings originated by the originating user, (b) a configuration setting established for the originating user, (c) a history of interactions with query results generated for query strings originated by the originating user before the received query string, (d) a history of browsing interactions by the originating user, or (e) an explicit designation of searching profile received in connection with the received query string.
